(19) United States
(12) Patent Application Publication
(10) Pub. No.: US 2007/0239575 A1
(43) Pub. Date: Oct. 11, 2007

(54) Generating revenue from a job recruiter

(76) Inventor: Christopher David Claridge, Oxley Garden (SG)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/410,470

(22) Filed: Apr. 24, 2006

(30) Foreign Application Priority Data
Apr. 7, 2006 (SG) 200602311-3

(51) Int. Cl. G06Q 40/00; G06Q 10/00; G06Q 30/00

(52) U.S. Cl. 705/35; 705/1; 705/40

(57) ABSTRACT

A system (10) for generating revenue from a job recruiter (30), the system (10) comprising: a web site (50) to publish a job advertisement (500) of the job recruiter (30) without charging a fee to the job recruiter (30); and a billing module (52) to charge a predetermined response fee to the job recruiter (30) when a job applicant (20) electronically submits their resume to the job recruiter (30) in response to the job advertisement (500).

### TECHNICAL FIELD

The invention concerns a system and method for generating revenue from a job recruiter.

### BACKGROUND OF THE INVENTION

In the past, an employer intending to fill a vacant position in their organization places an advertisement in the newspaper classifieds. In some cases, the employer outsources this responsibility to a professional recruitment agency. The agency then provides a shortlist of the most relevant candidates to the employer for their final decision. Newspaper classifieds are billed according to per display for a one day posting and are paid in advance of posting.

Due to the popularity of the Internet in recent years, online classifieds are increasingly used as they are convenient and available 24 hours a day 7 days a week. Online classifieds are billed according to per display for a 30 days posting period and are paid in advance of posting. Online recruitment is built around a database that is either proprietary or bespoke. The prospective employer pays a fixed fee to have their vacancy posted online for a fixed period of time. Payment for recruitment services is fixed irrespective of the outcome for the employer. Since a fixed fee per position is charged, the cost per response varies. In some cases, the there may be barely any responses to the job advertisement while the employer continues to be billed the fixed fee for each time period the job advertisement remains published.

Another way for employers to fill a vacant position is to search online resume databases. Rather than wait for job applicants to respond to their job advertisements, the employer searches resumes of job applicants who have submitted their resume to a web site previously. The employer inputs a search criteria to commence searching, for example, salary range, industry, or number of years of work experience in separated input text fields. The prospective employer pays a fixed fee which entitles them to search an online resume database and extract a fixed maximum number of candidate resumes. Alternatively, the prospective employer may extract any number of candidate resumes and then pay a fixed fee per resume extracted.

The three main recruitment channels have the following characteristics:

| Channel | Revenue Model | Average Expenditure |
|---|---|---|
| Agency | Fixed fee or percentage of salary | ˜S$10,000 |
| Advertising | Fixed fee per time period | ˜S$2,000 |
| Online | Fixed fee per time period | ˜S$150 |

In 2005, the revenue of the online recruitment industry is approximately US$3.5bn. It is expected to rise to US$12 billion by 2008. There are more than 4,000 participants globally. However, revenue is primarily generated from display advertising.

Typically, for an online employment web site, job applicants will be required to register themselves and enter their personal details. This is a time-consuming process and is generally inconvenient. Also, to search for relevant job advertisements, job applicants must use a rigid search mechanism based on arbitrary classifications of job advertisements. For example, they must select the location, industry sector, subsector, remuneration range and date of publication of the job advertisement, for jobs they are interested in applying for.

There is a desire for a system and method that can generate revenue from a job recruiter when recruiting for an available position that is highly targeted, minimises wastage in ongoing advertising costs and does not incur significant advertising expense initially.

### SUMMARY OF THE INVENTION

In a first preferred aspect, there is provided a system for generating revenue from a job recruiter, the system comprising:
a web site to publish a job advertisement of the job recruiter without charging a fee to the job recruiter; and
a billing module to charge a predetermined response fee to the job recruiter when a job applicant electronically submits their resume to the job recruiter in response to the job advertisement.

The job advertisement may be indexed by an indexer to facilitate free text searching of job advertisements by job applicants.

A free text search engine may be provided to enable job applicants to search for job advertisements based on key words.

Results from the free text search engine may also include suggestions for the job applicant to use other related key words if the number of results is below a predetermined number.

The job advertisement may include a user interface element for the job applicant to electronically submit their resume to the job recruiter.

A watermarking module may be provided to apply a watermark to an e-mail message with the resume that is forwarded to the job recruiter.

A resume store may be provided to store resumes of job applicants, and if a job applicant has their resume stored in the resume store, the job applicant electronically submits their resume to the job recruiter by retrieving their resume from the resume store without having to upload their resume again.

A multiple submission module may be provided to enable the job applicant to electronically submit their resume to multiple job advertisements at the same time.

In a second aspect, there is provided a method for generating revenue from a job recruiter, the method comprising:
publishing a job advertisement of the job recruiter without charging a fee to the job recruiter; and
charging a predetermined response fee to the job recruiter solely when a job applicant electronically submits their resume to the job recruiter.

The job advertisement may be indexed by an indexer to facilitate free text searching of job advertisements by job applicants.

A predetermined spending limit may be set by the job recruiter by specifying a predetermined number of resume submissions to be received.

An e-mail or text message may be automatically transmitted to the job recruiter requesting an increase in the predetermined number of resume submissions to be received when the number of resume submissions received by the job recruiter is within a predetermined range of the predetermined number.

A prepaid account associated with the job recruiter may be automatically debited in the amount of the predetermined response fee when each resume is submitted to the job recruiter.

The job advertisement may be published in any one of the group consisting of: print media, a web site, and an e-mail or text message sent to job applicants.

The job advertisement may include a user interface element for the job applicant to electronically submit their resume to the job recruiter.

In a third aspect, there is provided a system for generating revenue from a job recruiter, the system comprising:
a billing module to charge a predetermined response fee to the job recruiter when a job applicant electronically submits their resume to the job recruiter in response to a job advertisement;
wherein the job advertisement is published without charging a fee to the job recruiter.

The job recruiter may be a recruitment agent or an employer

The job advertisement may be an online job advertisement that includes a user interface element for the job applicant to electronically submit their resume to the job recruiter.

The user interface element may be a button or a hypertext link.

### BRIEF DESCRIPTION OF THE DRAWINGS

An example of the invention will now be described with reference to the accompanying drawings, in which:

FIG. 1 is a block diagram of a system in accordance with a preferred embodiment of the present invention;

FIG. 2 is a process flow diagram of a method in accordance with a preferred embodiment of the present invention;

FIG. 3 is a screenshot of a pricing web page in accordance with a preferred embodiment of the present invention;

FIG. 4 is a screenshot of a post new job advertisement page in accordance with a preferred embodiment of the present invention;

FIG. 5 is a screenshot of the job advertisement of FIG. 4 as published;

FIG. 6 is a screenshot of a search page and search results web page in accordance with a preferred embodiment of the present invention;

FIG. 7 is a screenshot of a current advertisement schedules web page in accordance with a preferred embodiment of the present invention; and

FIG. 8 is a screenshot of a login page for job recruiters in accordance with a preferred embodiment of the present invention.

### DETAILED DESCRIPTION OF THE DRAWINGS

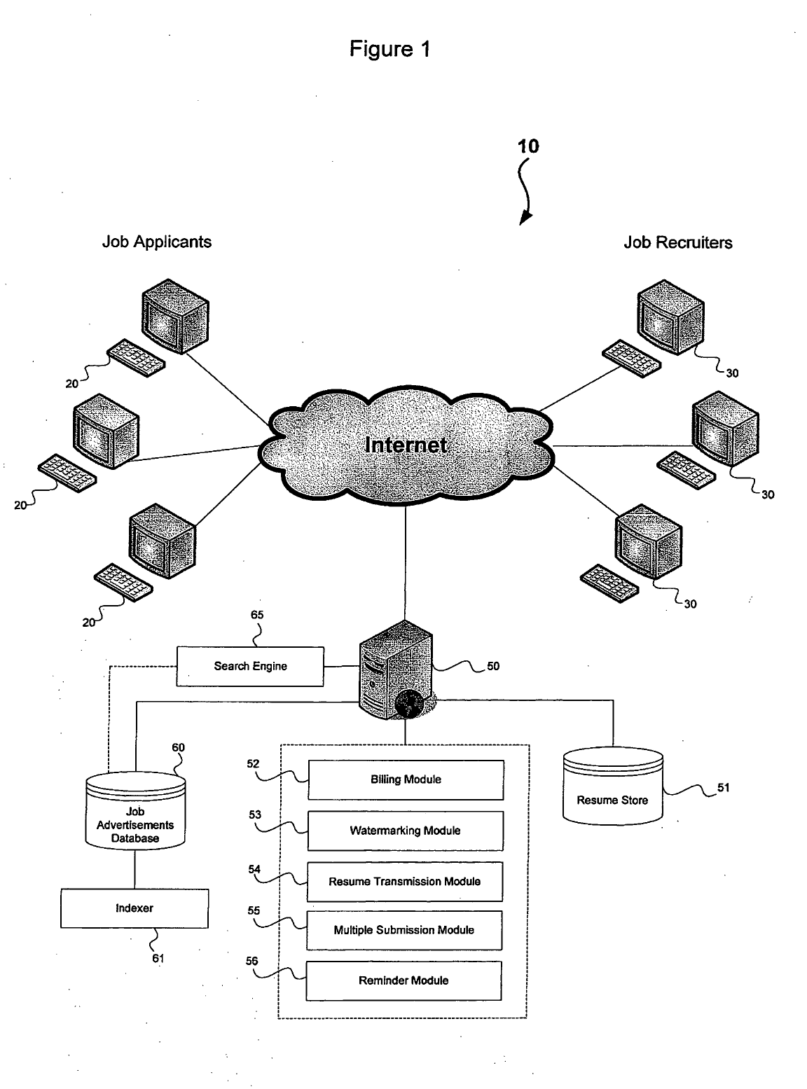

Referring to FIG. 1, a system 10 for generating revenue from a job recruiter 30 is provided. The system 10 comprises: a web site provided via a web server 50 and a billing module 52 that is executed on the web server 50. The web site 50 publishes job advertisements of job recruiters 30 without charging a fee to the job recruiters 30. The billing module 52 charges a predetermined response fee to the job recruiter 30 when a job applicant 20 electronically submits their resume to the job recruiter 30 in response to the job advertisement. In other words, the job recruiter 30 pays per response it receives from job applicants 20, to the web site 50 or service provider. Advantageously, the system 10 is highly targeted to relevant job applicants 20 since only job applicants 20 who believe they are suitable will respond to the job advertisement. Also, wastage in ongoing advertising costs is minimised. The job recruiter 30 only spends money when resumes are submitted. In contrast to a time limit, only a spending limit will determine when the job advertisement is removed. Furthermore, significant advertising expense is not initially incurred since job recruiter 30 pay for resumes that are submitted. Preferably, the job recruiter 30 may post a job advertisement without any upfront cost, and is only billed when resumes are submitted to them.

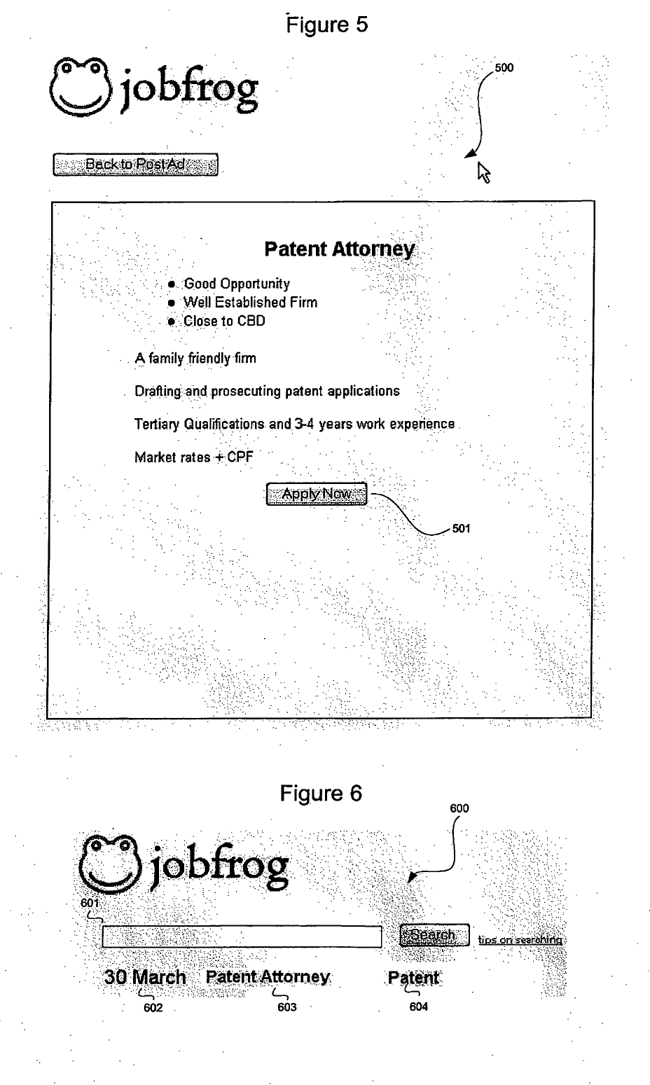

The system 10 also comprises an indexer 61 to index job advertisements for a free-text search engine 65 to enable job applicants 20 to search for job advertisements based on key words present in the job advertisement. Turning to FIG. 6, results from the free-text search engine 65 are displayed in a search results page 600. For example, the search results show the date of the job advertisement 602, the title of the job advertisement 603 and the industry that the job is within 604. Each search result shown is a hypertext link which when clicked, directs the user to the full job advertisement 500 as shown in FIG. 5. The search results page 600 may also include suggestions for the job applicant 20 to use other similar or related key words if the number of search results is below a predetermined number, for example, five job advertisements. This may be helpful if the job applicant 20 enters incorrect key words or may not know where to begin their job search. The job advertisements may also be stored in a job advertisements database 60 to enable convenient management and tracking of job advertisements by the job recruiters 30.

Preferably, job applicants 20 using the system 10 will not be required to register themselves and enter their personal details before responding to a job advertisement. This avoids time and inconvenience when applying for a job. To search for relevant job advertisements, job applicants 20 do not need to adhere to a rigid classification system of job advertisements. They may input key words including the location, industry sector, subsector, remuneration range and date of publication of the job advertisement, for jobs they are interested in applying for in the search input box 601 on the search page 600.

The system 10 also comprises a watermarking module 53 to apply a watermark to the e-mail message that is forwarded to the job recruiter 30 by the web site 50. The watermark is applied to an e-mail message before the submitted resume is forwarded to the relevant job recruiter 30 by a resume transmission module 54. The resume transmission module 54 automatically forwards the resume in an e-mail and directs it to the e-mail address provided by the job recruiter 30 when they created their job advertisement. The watermark may be a logo of the web site 50 or service provider to indicate that the resume has been submitted via the web site 50.

The system 10 also comprises a resume store 51 to store resumes of job applicants. The job applicant 20 may indicate this to occur when submitting their resume for the first time. If a job applicant 20 has their resume stored in the resume store 51, the job applicant 20 electronically submits their resume to the job recruiter 30 by retrieving their resume from the resume store 51 without having to upload their resume again. Conveniently, it saves the job applicant 20 as they do not need to wait for their resume to be uploaded repeatedly to the server side for each job advertisement they wish to respond to.

The system 10 also comprises a multiple submission module 55 to enable the job applicant 20 to electronically submit their resume to multiple job advertisements they wish to respond to at the same time. Conveniently, it saves the job applicant 20 as they do not need to wait for their resume to be uploaded each time for each job advertisement they wish to respond to, and they do not need click the “Apply Now” button 501 to respond to multiple job advertisements.

Referring to FIG. 5, the job advertisement 500 includes a user Interface element 501 for the job applicant to electronically submit their resume to the job recruiter. The user interface element 501 is a button or a hypertext link.

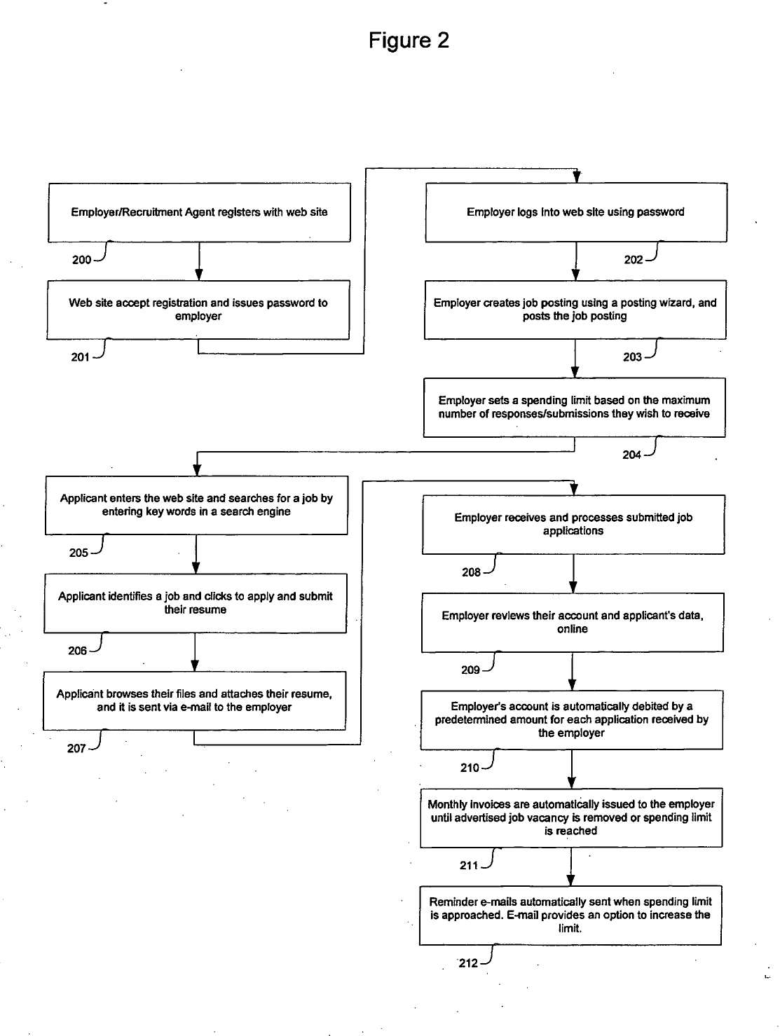

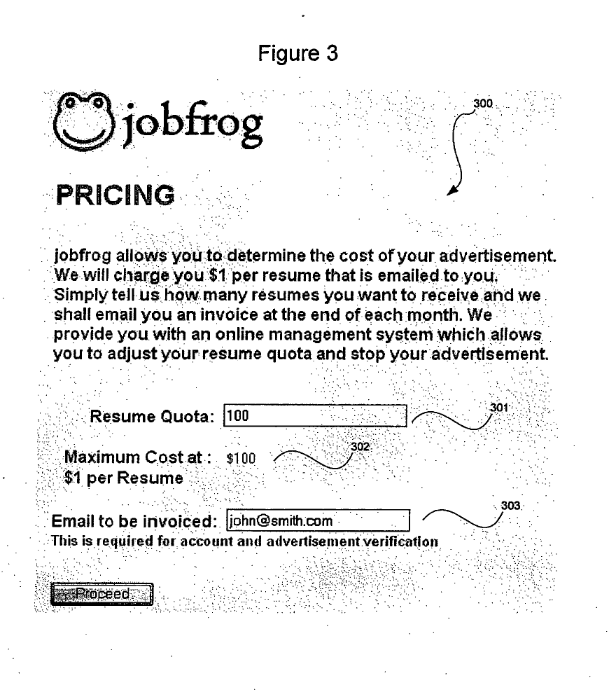

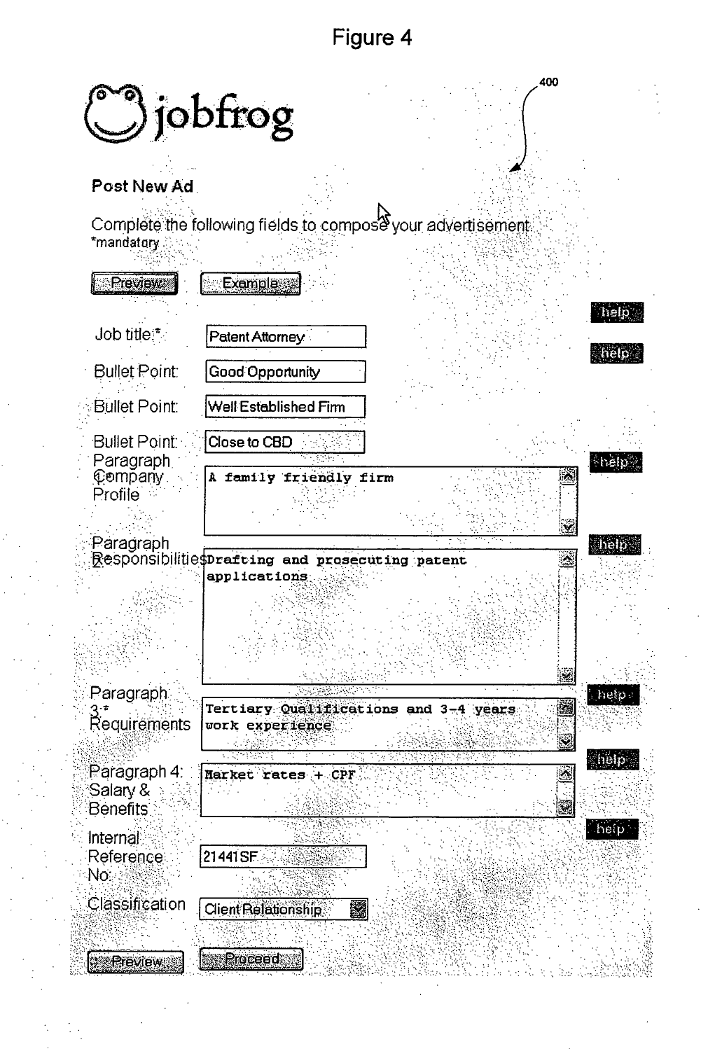

Referring to FIG. 2, in a typical scenario, an employer or recruitment agent acting on behalf of an employer registers 200 themselves with the web site 50 of the system 10. Registration involves entering details to identify the job recruiter 30, and how they will be billed by the billing module 52, for example, automatically via credit card or direct debit or by issuing monthly invoices. A prepaid account may also be created for the job recruiter 30. Upon verification of the job recruiter 30, the web site 50 accepts 201 their registration and issues a password to the job recruiter 30. The job recruiter 30 logs into 202 to the web site 50 using their e-mail address as the login name and their password as illustrated in FIG. 8. After authentication by the web site 50, the job recruiter 30 proceeds to create a job advertisement by clicking on the “Post Advertisement” link 803. The job recruiter 30 creates 203 a job advertisement using a posting wizard 400 as shown in FIG. 4 and subsequently the job advertisement is published on the web site 50. The job recruiter 30 then sets 204 a spending limit based on the maximum number of resumes they wish to receive as depicted in FIG. 3. The resume quota 301 is input and the maximum cost is calculated by multiplying the resume quota by the response fee per resume, for example, $1.00. The maximum cost is shown 302 to the job recruiter 30, for example, $100 for 100 resumes to be received. Also, the job recruiter 30 may indicate their e-mail address 303 to receive electronic invoices for the number of resumes received.

Job applicants 20 visit the web site 50 and searches for jobs they are interested in by entering key words on the search page 600 depicted on FIG. 6. The search engine 65 then searches 205 for matching job advertisements using the index generated by the indexer 61. The job advertisements may be retrieved from a job advertisements database 60. Based on the search results, the job applicant 20 identifies a job, a Patent Attorney job which directs them to the full job advertisement as shown in FIG. 5. The job applicant 20 may then apply for the job and submit 206 their resume to the job recruiter 30 by clicking the “Apply Now” button 501. The job applicant 20 submits their resume by browsing 207 through their local files and attaching it for upload to the web site 50. A watermarking module 53 applies a watermark to the e-mail message forwarded to the job recruiter 30 to indicate that the resume has passed the through the web site 50. Then, the resume transmission module 54 forwards the resume to the job recruiter 30. Alternatively, the job applicant 20 may be able to retrieve a copy of their resume stored in a resume store 51 on the server side and thus omit the step of attaching and uploading a local copy of their resume to the web site 50. This saves the job applicant 20 a lot of time.

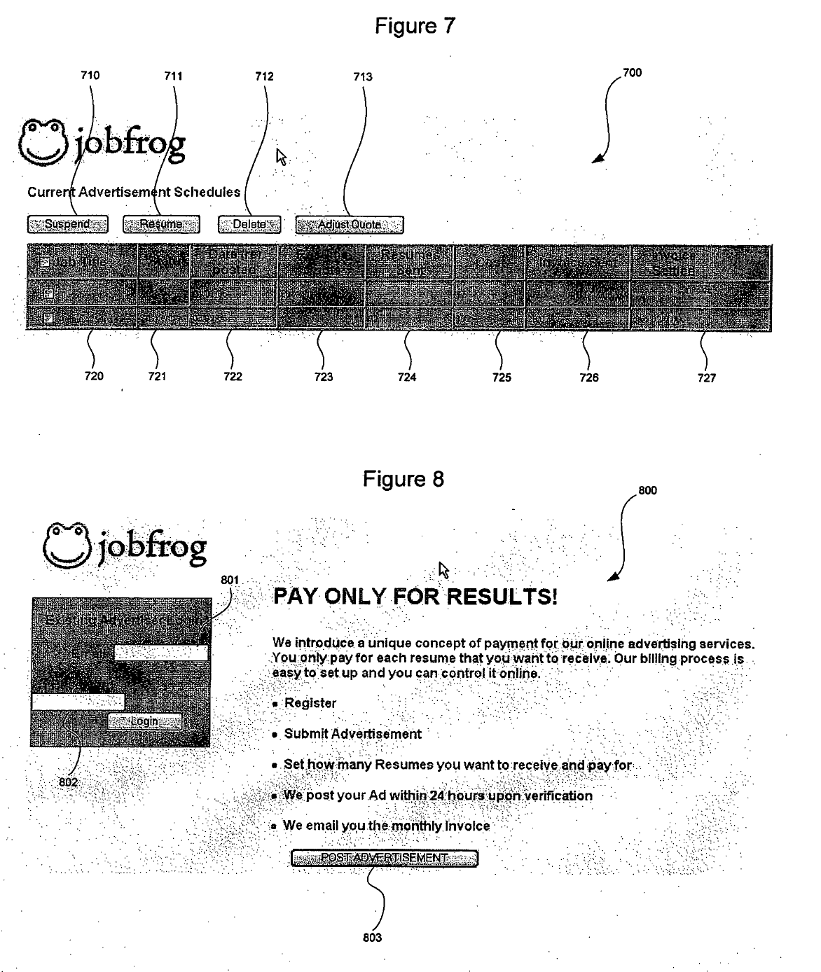

The job recruiter 30 receives 208 and processes the submitted resumes and job applications. Referring to FIG. 7, the job recruiter 30 may review 209 their current advertisements schedules to see how many resumes have been submitted for each job they have advertised through the web site 50. In the current advertisements schedule web page 700 there are eight columns in a table shown: job title 720, status of the job advertisement 721, publication date of the job advertisement 722, resume quota 723, number of resumes submitted 724, cost incurred 725, date of when invoice was/is to be sent 726 and invoice settlement date 727. The job recruiter 30 may select specific job advertisements (as records), and choose to: suspend the job advertisement 710 (if the position has been filled or withdrawn), resume a suspended job advertisement 711, delete an existing job advertisement 712 or adjust the resume quota 713. The current advertisements schedule web page 700 provides a real-time snapshot of all job advertisements of the job recruiter and enables to track costs accurately and ascertain the success rate of job advertisements. If certain job advertisements are attracting very little interest, the job recruiter 30 is in a knowledgeable position to modify or change their strategy accordingly. As resumes are submitted by job applicants 20, the prepaid account of the job recruiter 30 is debited 210 incrementally by the response fee per resume. Monthly invoices may also be automatically generated and issued 211 to the job recruiter 30 via the e-mail address 303 provided. Once the job vacancy has been filled or the spending limit reached, generation of the monthly invoices ceases and the job advertisement is delisted and its publication removed. If the spending limit is almost reached (by a preset warning level), a reminder e-mail is automatically transmitted 212 to the job recruiter 30 using a reminder module 56. An SMS may also be sent to the job recruiter 30 if desired. The reminder provides the job recruiter 30 with a convenient option to increase their spending limit by replying to the e-mail or SMS. This prevents the job advertisement from being delisted inadvertently if not intended by the job recruiter 30.

Although the job advertisement has been described as an online job advertisement, it is envisaged print media advertisements may also be used so long as the resume of the job applicant 20 is submitted electronically to the job recruiter 30. For example, the print media advertisement may provide a URL for the job applicant 20 to visit and enable submission of their resume.

Although it has been described that a watermark is applied to the e-mail message forwarded to the job recruiter 30, it may be possible to apply the watermark to pages of submitted resumes.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A system for generating revenue from a job recruiter, the system comprising:
a web site to publish a job advertisement of the job recruiter without charging a fee to the job recruiter; and
a billing module to charge a predetermined response fee to the job recruiter when a job applicant electronically submits their resume to the job recruiter in response to the job advertisement.

2. The system according to claim 1, wherein the job advertisement is indexed by an indexer to facilitate free text searching of job advertisements by job applicants.

3. The system according to claim 2, further comprising a free text search engine to enable job applicants to search for job advertisements based on key words.

4. The system according to claim 3, wherein results from the free text search engine also include suggestions for the job applicant to use other related key words if the number of results is below a predetermined number.

5. The system according to claim 1, wherein the job advertisement includes a user interface element for the job applicant to electronically submit their resume to the job recruiter.

6. The system according to claim 1, further comprising a watermarking module to apply a watermark to an e-mail message with the resume that is forwarded to the job recruiter.

7. The system according to claim 1, further comprising a resume store to store resumes of job applicants, and if a job applicant has their resume stored in the resume store, the job applicant electronically submits their resume to the job recruiter by retrieving their resume from the resume store without having to upload their resume again.

8. The system according to claim 1, further comprising a multiple submission module to enable the job applicant to electronically submit their resume to multiple job advertisements at the same time.

9. A method for generating revenue from a job recruiter, the method comprising:
publishing a job advertisement of the job recruiter without charging a fee to the job recruiter; and
charging a predetermined response fee to the job recruiter solely when a job applicant electronically submits their resume to the job recruiter.

10. The method according to claim 9, wherein the job advertisement is indexed by an indexer to facilitate free text searching of job advertisements by job applicants.

11. The method according to claim 9, wherein a predetermined spending limit is set by the job recruiter by specifying a predetermined number of resume submissions to be received.

12. The method according to claim 11, wherein an e-mail or text message is automatically transmitted to the job recruiter requesting an increase in the predetermined number of resume submissions to be received when the number of resume submissions received by the job recruiter is within a predetermined range of the predetermined number.

13. The method according to claim 9, wherein a prepaid account associated with the job recruiter is automatically debited in the amount of the predetermined response fee when each resume is submitted to the job recruiter.

14. The method according to claim 9, wherein the job advertisement is published in any one of the group consisting of: print media, a web site, and an e-mail or text message sent to job applicants.

15. The method according to claim 9, wherein the job advertisement includes a user interface element for the job applicant to electronically submit their resume to the job recruiter.

16. A system for generating revenue from a job recruiter, the system comprising:
a billing module to charge a predetermined response fee to the job recruiter when a job applicant electronically submits their resume to the job recruiter in response to a job advertisement;
wherein the job advertisement is published without charging a fee to the job recruiter.

17. The system according to claim 16, wherein the job recruiter is a recruitment agent or an employer

18. The system according to claim 16, wherein the job advertisement is an online job advertisement that includes a user Interface element for the job applicant to electronically submit their resume to the job recruiter.

19. The system according to claim 18, wherein the user interface element is a button or a hypertext link.
